(19) United States
(12) Patent Application Publication
(10) Pub. No.: US 2020/0134445 A1
(43) Pub. Date: Apr. 30, 2020

(54) ARCHITECTURE FOR DEEP Q LEARNING

(71) Applicant: Advanced Micro Devices, Inc., Santa Clara, CA (US)

(72) Inventors: Shuai Che, Kirkland, WA (US); Jieming Yin, Bellevue, WA (US)

(73) Assignee: Advanced Micro Devices, Inc., Santa Clara, CA (US)

(21) Appl. No.: 16/176,903

(22) Filed: Oct. 31, 2018

(51) Int. Cl. G06N 3/08; G06N 3/04

(52) U.S. Cl. CPC G06N 3/08; G06N 3/0445; G06N 3/0472

(57) ABSTRACT

The deep Q learning technique trains weights of an artificial neural network using a number of unique features, including separate target and prediction networks, random experience replay to avoid issues with temporally correlated training samples, and others. A hardware architecture is described that is tuned to perform deep Q learning. Inference cores use a prediction network to determine an action to apply to an environment. A replay memory stores the results of the action. Training cores use a loss function derived from outputs from both the target and prediction networks to update weights of the prediction neural networks. A high speed copy engine periodically copies weights from the prediction neural network to the target neural network.

### BACKGROUND

Machine learning is a large family of techniques that attempt to automatically generate algorithms for solving problems through a training process. Often, machine learning algorithms utilize artificial neural networks as the basis for the algorithms. A wide variety of neural network-based machine learning techniques exist and are being developed.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the machine learning device illustrated in FIG. 1, according to an example;

FIGS. 3 and 4 present details of data flow through the machine learning device 103, according to examples; and

FIG. 5 is a flow diagram of a method for training an artificial neural network, according to an example.

### DETAILED DESCRIPTION

The deep Q learning technique trains weights of an artificial neural network using a number of unique features, including separate target and prediction networks, random experience replay to avoid issues with temporally correlated training samples, and others. The present disclosure includes a hardware architecture tuned to perform deep Q learning. Inference cores use a prediction network to determine an action to apply to an environment. A replay memory stores the results of the action. Training cores use a loss function derived from outputs from both the target and prediction networks to update weights of the prediction neural networks. A high speed copy engine periodically copies weights from the prediction neural network to the target neural network. Additional details are provided below.

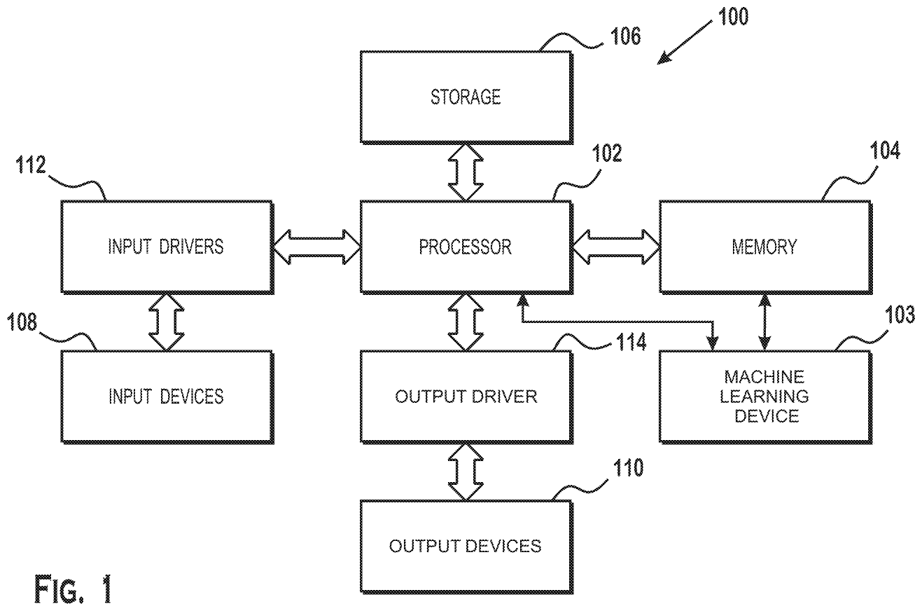

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In some alternatives, the processor 102 can include or be embodied as a field programmable gate array (FPGA). In various alternatives, the memory 104 is be located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

A machine learning device 103 is included within the device 100. The machine learning device 103 includes hardware components, such as processors and memory, that work together to train a neural network using deep Q learning. Deep Q learning, described, for instance, in “Playing Atari with Deep Reinforcement Learning,” by Mnih et al., and in “Deep Reinforcement Learning: An Overview,” by Yuxi Li, available at https://arxiv.org/pdf/1701.07274.pdf, is a technique whereby an artificial neural network is trained to determine what action to take in an environment given the state of the environment. In general, the deep Q learning technique trains a neural network based on an environment by adjusting the weights of neurons in an artificial neural network during a training process. After training, the artificial neural network may be used to control an agent in an environment.

Broadly, a neural network consists of layers of interconnected artificial neurons. The first layer is an input layer that accepts certain inputs and the last layer is an output layer than provides outputs. One or more hidden layers may exist between the input and output layers. Each neuron accepts input from one or more neurons of the previous layer (i.e., towards the direction of the input layer), applies an operation (usually referred to as a transfer function) to the inputs, where the values of the provided inputs are adjusted based on the values of weights, and provides an output to one or more artificial neurons of the next layer (i.e., towards the direction of the output layer). The architecture of the neural network—that is, the interconnectedness of each artificial neuron and the transfer functions of each artificial neuron—is pre-designated (e.g., by a designer). The training process is the process of determining the values for each of the weights. Generally, training occurs by providing training input to the neural network, recording output, determining a “cost” (or “loss function”) for the output of the neural network, and adjusting the weights of the neural network to minimize the cost. Conceptually, the “cost” represents the inaccuracy of the output of the neural network in accomplishing a desired task.

Deep Q learning includes a number of specific features that allow for a neural network to be trained to determine a particular action to take given the current state of an environment. A full expression of the deep Q learning technique is now provided. This technique is described with respect to training an artificial neural network to play video games. Thus, the specific input type of pixel inputs are described herein. However, the techniques may be applicable for a variety of situations and need not be used to play video games. Expressed in pseudo-code, the deep Q learning technique is described in the following manner.

TABLE 1
Deep Q Learning

```
Input: environment states
Output: action value function (trained weights θ)
Initialize replay memory D
Initialize action-value function Q with random weights θ
Initialize target action-value function \hat{Q}^ with weights θ⁻ = θ
For episode = 1 to M do
  Obtain initial environment state s₁
  For t =1 to T do
    $Select {a}_{t} = \{ \begin{matrix}a random action & with probability ϵ \\ {argmax}_{a} Q ( {s}_{t} , a ; θ ) & otherwise\end{matrix}$
    Execute action aₜ in environment and observe reward rₜ and state sₜ₊₁
    Store tuple (sₜ, aₜ, rₜ, sₜ₊₁) in D
    Sample one or more random tuples (sⱼ, aⱼ, rⱼ, sⱼ₊₁) from D
    $Set {y}_{j} = \{ \begin{matrix}{r}_{j} & if episode terminates at step j + 1 \\ {r}_{j} + γ {max}_{{a}^{′}} \hat{Q} ( {s}_{j + 1} , {a}^{′} ; {θ}^{-} ) & otherwise\end{matrix}$
    Perform a gradient descent step on (yⱼ − Q(sⱼ, aⱼ; θ))² w.r.t. θ
    Every C steps, set θ⁻ = θ
  End
End
```

The goal of the deep Q learning technique is to train the weights of an artificial neural network so that the artificial neural network can be used to select actions to apply to an environment in order to maximize the long-term reward (where a “reward” is a value output by the environment). The weights of the “main” neural network (also referred to as the “prediction” neural network) are referred to as θ, and the output function of the neural network is defined as Q. A second neural network, referred to as a “target” neural network, and having weights θ⁻, exists as part of the training process and is used to stabilize loss calculation as described in further detail below. The output function of the target neural network is referred to as \hat{Q} in Table 1.

Both neural networks (Q and \hat{Q}) have the same neural network architecture. In other words, these two neural networks have a number of artificial neuron layers. Each layer includes a number of neurons, each of which is defined by a set of weights on input, a transfer function that defines an output given the values of inputs and the weights applied to the values, connectivity to artificial neurons in a previous layer (or inputs to the neural network), and connectivity to artificial neurons in a subsequent layer (or outputs to the neural network). This architecture is the same for both the prediction and the target neural networks.

In operation, the input layer accepts inputs to the neural network. These inputs are the state of the environment (sᵢ). For deep Q learning networks used to process a series of images and output a recommended action, the input comprises information about the image at a particular point in time. In some implementations, the input is color values of a series of pixels of an image, optionally pre-processed by a pre-processing operation (which can, for example, reduce resolution, compress the color space, or the like, to reduce the complexity of the neural network).

The inputs are processed through the artificial neurons of the artificial neural network based on the transfer functions, weights, and interconnectivity of the individual neurons. The output layer outputs a score for each action of a set of possible actions. The score indicates the “desirability” of choosing a particular action, given the state of the environment sⱼ. Thus the artificial neural network is used to determine an action to take based on the state of the environment by feeding that state in, observing the output scores, and selecting the most desirable (e.g., highest) score.

The deep Q learning technique is not concerned with the specific architecture (transfer functions and neuron interconnectivity) of the neural network to be trained, but rather with determining the weights for each of the neurons through an iterative training process. The training technique updates these weights by determining a loss function value based on output from the target and prediction neural networks and on an observed reward. More specifically, the training technique uses tuples that indicate the state changes (including the first state, sₜ and second state sₜ₊₁), when a particular action is applied to the environment, and the reward observed for that state change. For a particular weight update, the training technique calculates a loss function based on a tuple. For a tuple recorded for time step j, the training technique calculates a loss function based on the reward observed rⱼ, the maximum Q value for step j+1 for the target network, and the Q value of the prediction network based on the state at time j for the action specified in the tuple. Then, the neural network adjusts the weights of the neural network in order to minimize the loss function (e.g., using a gradient descent operation).

The advances provided by the deep Q learning technique, as compared with older learning techniques, include the use of separate “target” and “prediction” networks as well as the use of a replay memory to sample random tuples for training. In training, the reward for the later state (sⱼ₊₁) is calculated based on the less-frequently-updated target network, while the reward for the earlier state (sⱼ) is calculated based on the more-frequently-updated prediction network. In addition, the tuples that are generated based on applying actions to the environment are sampled from randomly, instead of sequentially. The above features provide stability to the training process and avoid issues related to the usage of temporally correlated tuples.

The deep Q learning technique described in Table 1 will now be described in further detail. The input to the technique is the states of the environment observed, and the output is a trained action value function Q, representing the prediction network with trained weights. The technique utilizes a replay memory D to store tuples generated based on interaction with the environment. The action-value function Q, which represents the prediction network, has weights θ, which are initialized randomly or in any desired manner. The target action value function \hat{Q}, which represents the target network used in training, has weights θ⁻, which are initialized to be equal to the weights of the prediction network θ (or may alternatively be initialized in any technically feasible manner).

Training proceeds through a number of episodes, which is represented by the outer for loop of 1 to M. In the example of video game play, each episode represents a playthrough through a single game. At the beginning of each episode, the state s₁ is initialized based on the initial state of the environment. Then, the inner for loop iterates through multiple time steps of the episode. In an example, each time step represents a single video game frame, where a subsequent time step (e.g., t+1) occurs one or more frames after the immediately earlier time step (t). Note, it is possible for adjacent time steps to be taken from video frames having an interval of more than 1 (e.g., it possible for time step t to correspond to video frame 1, time step t+1 to correspond to video frame 3, time step t+2 to correspond to video frame 5, and so on).

In the inner for loop, the technique selects an action aₜ to perform on the environment at time step t. The selection is performed in the following manner. With probability ϵ, the technique selects a random action out of the possible actions. With probability 1−ϵ, the technique selects the action (a) that produces the highest score (Q(sₜ, a; θ)) when the state for the current time step is input to the prediction network. Using a random action with probability ϵ allows the training technique to “explore” actions other than those that would be recommended by the network, at least some of the time, to increase the diversity of tuples generated.

The technique executes the chosen action aₜ in the environment and observes the output reward rₜ and the state for the next time step sₜ₊₁. Then, the technique stores a tuple consisting of the state at time step t (sₜ), the state at time step t+1 (sₜ₊₁), the action that was taken to cause that transition to occur (aₜ), and the reward experienced (rₜ) in response to the action taken at state sₜ. It should be understood that the reward is a value that represents some sort of feedback received from the environment. In the video game example, the reward is a score or progress through a level.

After generating the tuple, the training technique uses one or more tuples to train the weights θ of the prediction network. As described above, this training occurs by adjusting the weights of the prediction network to minimize the loss function using a gradient descent step. The loss function is defined in the technique of table 1 in the following manner: (yⱼ−Q(sⱼ, aⱼ; θ))². As shown in table 1, yⱼ is the actual reward experienced at time j when action aⱼ is applied, plus the reward predicted by the target network \hat{Q} at time j+1, for the action that produces the highest reward, multiplied by a discount factor γ, which is between 0 and 1, and which reflects the fact that a future reward (that is, the reward at time step j+1) is “worth” less than a current reward (that at time step j). At the last time step, yⱼ is simply set to rⱼ, since there is no future reward by definition. Q(sⱼ, aⱼ; θ) is the reward output by the prediction network for state sⱼ and action aⱼ. The gradient descent technique is a well-known operation that, through back-propagation, updates the weights of the prediction network to minimize the loss function.

At the end of the inner for loop, the training technique sets the weights of the target network to be equal to those of the prediction network if C number of steps have passed since the last such update. As described above, the target network is updated less frequently than the prediction network so that the target calculation portion of the loss function calculation has “stability” and is less affected by individual weight updates.

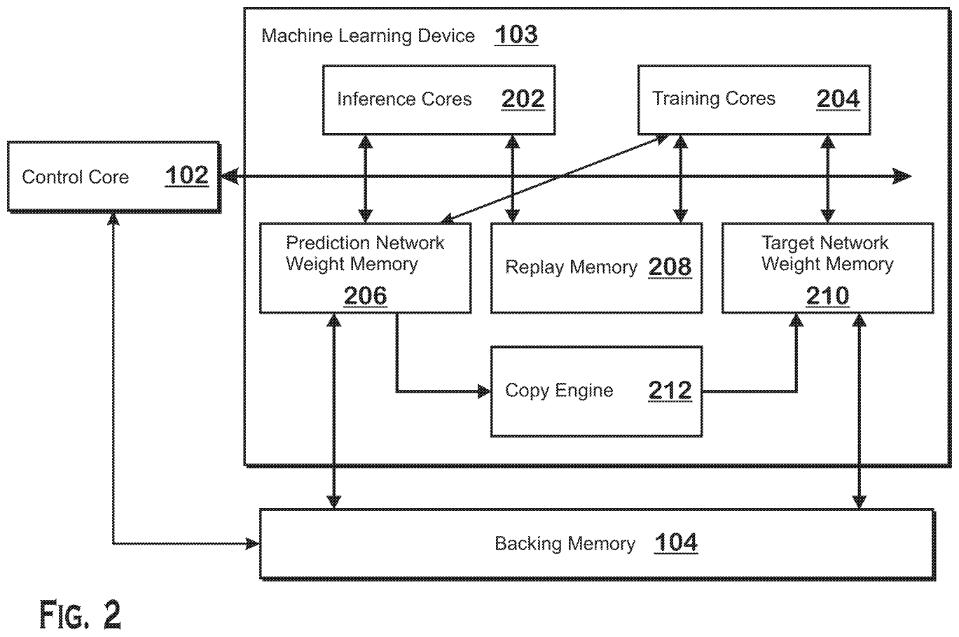

Current processing architectures are not optimized to implement the deep Q learning technique. Therefore FIGS. 2-5 present an architecture for implementing deep Q learning.

FIG. 2 is a block diagram of the machine learning device 103 illustrated in FIG. 1, according to an example. The machine learning device 103 includes one or more inference cores 202, one or more training cores 204, a prediction network weights memory 206, a replay memory 208, a target network weights memory 210, and a copy engine 212. Backing memory 104 is also shown.

The control core 102 is a processor that directs the inference cores 202 and the training cores 204 to perform deep Q learning. The control core 102 may also perform other functions such as running software that acts as the environment (e.g., a video game), applying a chosen action to the environment and reporting the resulting state to the machine learning device 103, applying pre-processing (such as down-scaling and color space reduction) to the environment state for reporting to the machine learning device 103, initiating the deep Q learning technique on the machine learning device 103, and other functions.

The prediction network weight memory 206 stores the weights for the prediction network (Q) and is directly accessible both by the inference cores 202 and the training cores 204. The target network weight memory 210 stores the weight for the target network (\hat{Q}) and is directly accessible by the training cores 204 but not by the inference cores 202, which do not use the target network. The replay memory 208 stores the tuples generated by the inference cores 202 for use by the training cores 204. The copy engine 212 performs the copy of the prediction network weights into the target network weight memory 210.

The backing memory 104 is memory that stores a copy of the data in the prediction network weight memory 206 and the target network weight memory 210. In an example, the backing memory 104 is a lower level memory of a memory hierarchy. Specifically, the backing memory 104 may be system memory, while the memories that store weights are similar to a cache memory.

The inference cores 202 and training cores 204 are processors that perform aspects of deep Q learning. These cores may be any technically feasible type of processor such as a programmable microcontroller or microprocessor, a highly parallel programmable architecture like a graphics processing unit, a field programmable gate array, or a hard wired circuit. The inference cores 202 may be optimized for performing tuple generation (e.g., reduced latency with an architecture similar to a central processing unit) while the training cores 204 are optimized for throughput (e.g., increased throughput with a highly parallel architecture such as that of a graphics processing unit).

The inference cores 202 perform the step of:

TABLE 2
Tuple generation

$Select {a}_{t} = \{ \begin{matrix}a random action & with probability ϵ \\ {argmax}_{a} Q ( {s}_{t} , a ; θ ) & otherwise\end{matrix} .$

Thus, with probability 1−ε, the inference cores 202 apply the state for time step t (sₜ) to the prediction network and select the action that corresponds to the highest of the action scores that are output. This application involves performing the calculations of all of the interconnected artificial neurons as specified by the neural network architecture the and the weights θ, including calculating the results of the transfer functions of neurons. The output layer includes multiple artificial neurons, each of which corresponds to a different action. Thus the action with the highest score is determined by examining the outputs of the output layer neurons. With probability ϵ, the inference cores 202 select a random action.

The inference cores 202 transmit the chosen action to the control core 102 for application to the environment. The control core 102 returns the reward for that action and the resulting state of the environment to the machine learning device 103. The replay memory 208 stores a tuple indicating the pre-action state sₜ, the action taken aₜ, the reward for the action rₜ, and the post-action state sₜ₊₁.

The training cores 204 perform the following steps based on both the prediction network weights and the target network weights:

TABLE 3
Training

Sample one or more random tuples (s_{j,} aⱼ, rⱼ, sⱼ₊₁) from D
$Set {y}_{j} = \{ \begin{matrix}{r}_{j} & if episode terminates at step j + 1 \\ {r}_{j} + γ {max}_{{a}^{′}} \hat{Q} ( {s}_{j + 1} , {a}^{′} ; {θ}^{-} ) & otherwise\end{matrix}$
Perform a gradient descent step on (yⱼ − Q (sj, aⱼ; θ))² w.r.t.θ

In other words, the training cores 204 sample tuples from the replay memory 208, determine yⱼ based on the reward from the tuples and application of the state sⱼ₊₁ to the target network to obtain the highest action value, determines the result of a loss function based on yⱼ and based on the output of the prediction network for action aⱼ, and performing a gradient descent step on the loss function as shown above in Table 3. In some implementations, the training cores 204 sample multiple tuples at a time (a “minibatch”) and use a weight adjustment step to adjust weights of the prediction network based on those multiple tuples (such as minibatch gradient descent). In an example, the training cores 204 calculate a gradient for each of the tuples, average or sum the gradients, and use the summed or averaged gradient to determine adjustments to the weights that would result in maximum reduction in loss function.

As described above, the copy engine 212 periodically (i.e., every C number of time steps) copies the weights from the prediction network weight memory 206 to the target network weight memory 210. The copy engine 212 is an engine such as a direct memory access engine that is programmed to perform the above copy operations independent of any control mechanism, and to do so in a high speed manner. In some implementations, the target network weights are inaccessible to the training cores 204 while the weights are being copied from the prediction network weight memory 206 to the target network weight memory 210. In some implementations, double buffering is used so that the copy can occur to a standby buffer while the training cores 204 are accessing a primary buffer. According to such a scheme, when the copy is complete, the role of the buffers are switched (i.e., the standby buffer becomes the primary buffer and the primary buffer becomes the standby buffer).

In some implementations, the replay memory 208 is embodied as a circular buffer. The entity that writes tuples into the replay memory 208 (e.g., the inference cores 202) maintains a head pointer into the replay memory 208. After the writing entity writes a tuple into the replay memory 208, the writing entity increments the write pointer by 1 (or the size of a tuple) and performs a modulo on that pointer by the size of the replay memory 208. The replay memory 208 stores an indication of whether the replay memory 208 is full. If the replay memory 208 is full, the writing entity writes a new entry into the replay memory 208 such that the new entry overwrites the oldest entry in the replay memory 208. Additionally, when reading the replay memory 208 for training (i.e., when sampling the tuples), the training cores 204 do not sample tuples past the head pointer if the replay memory 208 is not full, because such tuples are not valid.

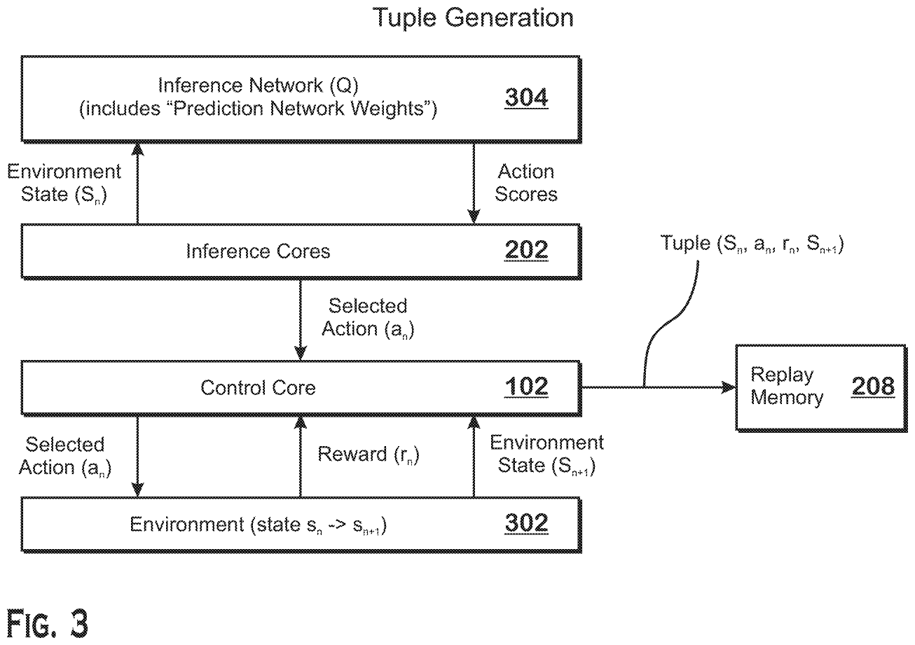

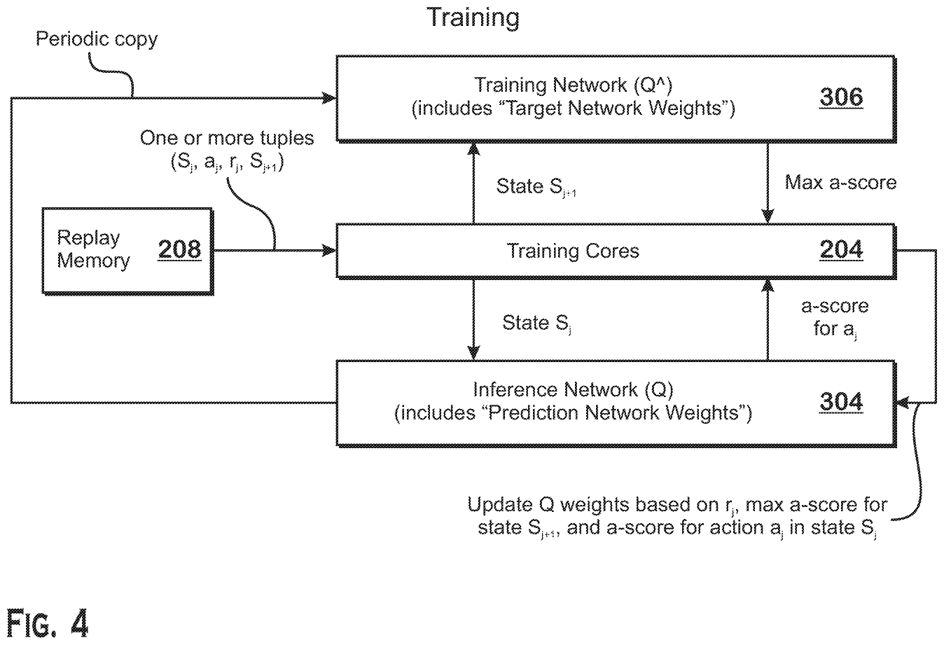

FIGS. 3 and 4 present details of data flow through the machine learning device 103, according to examples. FIG. 3 illustrates data flow through the machine learning device 103 for tuple generation, according to an example. To begin, the inference cores 202 apply the state at time step n (sₙ) to the inference network 304 and obtain action scores in response. The inference network 304 is the artificial neural network that uses the prediction network weights θ, and includes both the weights as well as the transfer functions and interconnections of the artificial neurons. These transfer functions, and the neuron connections, can be stored in any technically feasible manner, such as data in a memory, programmatically in machine instructions, as circuitry, or as any combination thereof. The inference cores 202 select the action aₙ corresponding to the highest action score output by the prediction network and apply the action to the environment 302. As stated above, selection of the action in the above manner occurs with probability 1−ϵ (i.e., approximately ϵ*100 percent of the time), since an action is chosen randomly with probability ϵ. The environment processes the action an and returns a reward rₙ and an environment state sₙ₊₁ to the control core 102. The control core 102 stores a tuple including sₙ, aₙ, rₙ, and sₙ₊₁ in the replay memory 208 for use in training.

FIG. 4 illustrates data flow through the machine learning device 103 for training, according to an example. The training cores 204 select a tuple including sj, aⱼ, rⱼ, and sⱼ₊₁. The training cores 204 apply state sⱼ to the inference network and obtain the score corresponding to the action aⱼ. The training cores 204 also apply state sⱼ₊₁ to the training network 306, which includes the target network weights and the same artificial neural network architecture (neuron transfer functions and interconnectivity) as the inference network 304. The training cores 204 receive the maximum a score in response to the input for the state sⱼ₊₁ from the training network 306. The training cores 204 then update the weights of the inference network based on the loss function described in Table 1. In some implementations, updating the weights includes performing a gradient descent step. Periodically, the copy engine 212 copies the weights from the inference network 304 to the training network 306. Note, the “inference network” and “prediction network” have the same architectures but can have different weights.

Several optimizations are possible. In one optimization, the training cores 204 are not synchronized with the generation of tuples by the inference cores 202. More specifically, the inner for loop of the deep Q learning technique of Table 1 includes a tuple generation step followed by a training step. However, these operations can be performed in parallel. In other words, the inference cores 202 can be applying a state to the prediction network and choosing an action and the environment can be applying the action to the internal state of the environment while the training cores 204 are updating the inference network 304. It is not necessary for training to occur only with the most recent tuple generated by the inference cores 202 available. (In other words, it is possible for the inference cores 202 to be generating a tuple while the training cores 204 are updating the weights of the prediction network with tuples that are slightly “stale” due to not including the tuple currently being generated by the inference cores 202 in conjunction with the environment).

Another optimization involves compressing the replay memory 208. Specifically, each tuple stores state data for adjacent time steps (t and t+1). However, because the replay memory 208 stores sequences of tuples, the state data would be duplicated if each tuple is stored fully. Thus, according to this optimization, the replay memory 208 stores only the state for the first time step in each slot, except for the most recent tuple stored, which stores both the state for t and the state for t+1. Thus, each slot in the replay memory 208 stores sₜ, aₜ, and rₜ, and not sₜ₊₁, which is stored in the next slot (again, except for the most recent tuple stored).

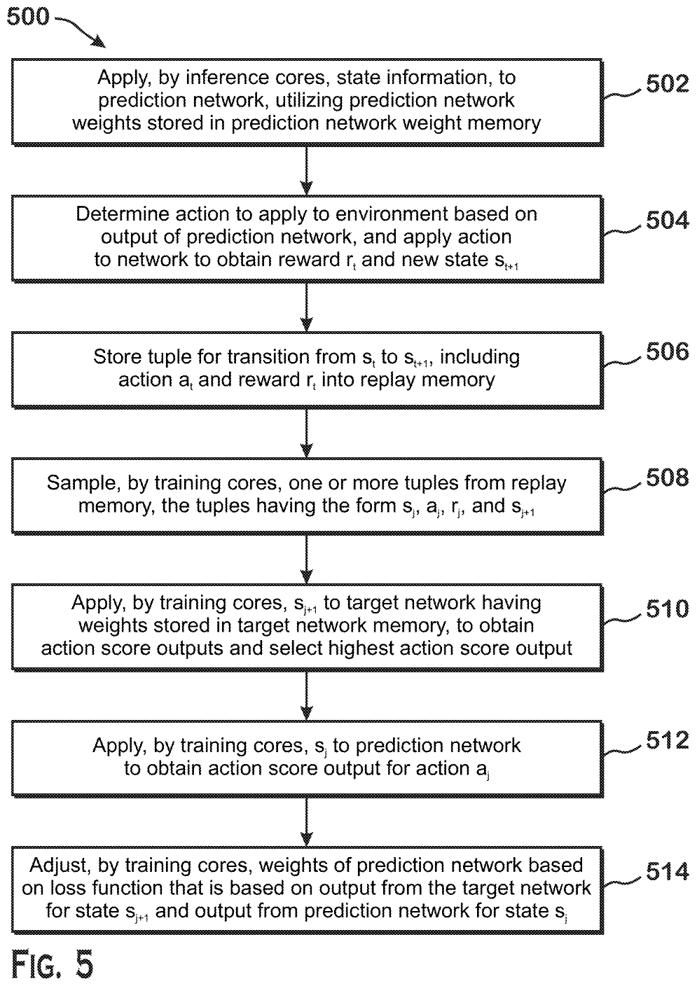

FIG. 5 is a flow diagram of a method for training an artificial neural network, according to an example. Those of skill in the art will understand that although the boxes corresponding to steps are visually depicted in FIG. 5 in a particular order, any technically feasible order (for example, allowing for parallelism) is within the scope of the present disclosure. Additionally, the method 500 of FIG. 5 describes training for a single time step and thus corresponds to the inner for loop of the technique illustrated in Table 1. It should be understood that the method 500 would be repeated for each time step until the episode ends and then would be repeated for multiple episodes.

The method 500 begins at step 502, where the inference cores 202 apply state information to a prediction network having prediction network weights stored in the prediction network weights memory 206. The state information is deemed to be state information from the environment at time step t (thus having symbol sₜ), optionally pre-processed. As described elsewhere herein, the prediction network weights are stored in prediction network weight memory 206, and the architecture of the prediction network (i.e., the interconnectivity and transfer function) is stored or encoded in any technically feasible manner (such as within the prediction network weight memory 206, in a different memory, or encoded programmatically or in a hard-wired manner in circuitry).

The prediction network outputs a set of scores for each possible action. The inference cores 202 select the action (aₜ) corresponding to the highest score to be applied to the environment. The inference cores 202 forward this selection to the control core 102, which applies the selected action to the environment, observes the reward (rₜ) for the selected action, and the new state (sₜ₊₁).

Note that step 502, and the “determine action based on output of prediction network” portion of step 504 do not occur in every training step iteration (the inner for loop of the technique of Table 1), since, as described in Table 1, a random action is sometimes chosen (with probability ϵ). However, these steps do of course occur in steps where a random action is not chosen, as in steps where a random action is not chosen, an action is chosen by selecting the action with the highest score based on the output of the prediction network. Further, even when the action is chosen randomly, that action is still applied to the environment and the reward and new state are obtained in step 504.

At step 506, the replay memory 208 stores a tuple corresponding to the state transition, including the first state sₜ, the action taken for the transition aₜ, the reward for taking the action provided by the environment rₜ, and the state resulting from applying the action aₜ to state sₜ. In some implementations, the replay memory 208 is or includes a circular buffer and a new entry placed into the replay memory 208 overwrites either an empty slot or the oldest entry. In some implementations, only the most recent tuple stores state sₜ₊₁ for that tuple, since the sₜ for one tuple can be used as the sₜ₊₁ for the immediately preceding tuple.

At step 508, training begins. The training cores 204 sample one or more tuples (in some implementations, a “minibatch”) from the replay memory 208, where each tuple has the form sⱼ, aⱼ, rⱼ, and sⱼ₊₁. Steps 510-514 are steps for determining the loss function value and for adjusting weights of the prediction network. At step 510, the training cores 204 apply state sⱼ₊₁ to the target network, which has weights stored in the target network weight memory 210. The training cores 204 obtain the highest action score output from the target network. At step 512, the training cores 204 apply state sⱼ to the prediction network, which has weights stored in the prediction network weight memory 206, and obtain an action score output for the action specified in the tuple aⱼ. At step 514, the training cores 204 adjust the weights of the prediction network based on a loss function calculated based on the output of steps 510 and 512. In some implementations, the loss function is (yⱼ−Q(sⱼ, aⱼ; θ))² and weight adjustment is performed through gradient descent.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for training a prediction artificial neural network, the method comprising:
applying, by one or more inference cores, state information for time step t to a prediction artificial neural network having weights stored in a prediction network weight memory, to obtain output scores for a set of actions;
selecting an action from the set of actions based on the output scores, for application to an environment, to advance the environment to time step t+1;
storing a tuple for a transition from state sₜ to state sₜ₊₁ into a replay memory, the tuple including the selected action, and a reward provided by the environment;
adjusting, by the one or more training cores, weights of the prediction artificial neural network stored in the prediction network weight memory based on application of states sₜ and sₜ₊₁ from the tuple to the prediction artificial neural network and a target artificial neural network having weights stored in a target network weight memory, respectively.

2. The method of claim 1, wherein adjusting the weights of the prediction artificial neural network includes:
sampling, by one or more training cores, one or more tuples from the replay memory, where each tuple includes a state sⱼ, an action aⱼ, a reward for the action rⱼ, and a subsequent state sⱼ₊₁.

3. The method of claim 2, wherein adjusting the weights of the prediction artificial neural network further includes:
applying, by the one or more training cores, state sⱼ₊₁ to a target artificial neural network having weights stored in a target network weight memory and obtaining a highest action score output from the target artificial neural network.

4. The method of claim 3, wherein adjusting the weights of the prediction artificial neural network further includes:
applying, by the one or more training cores, state sⱼ to the prediction artificial neural network to obtain an action score for action aⱼ.

5. The method of claim 4, wherein adjusting the weights of the prediction artificial neural network further includes:
determining, by the one or more training cores, a loss function based on the highest action score output by the target artificial neural network for state sⱼ₊₁, the action score for action aⱼ output by the prediction artificial neural network, and the reward score rⱼ.

6. The method of claim 5, wherein adjusting the weights of the prediction artificial neural network further includes:
performing, by the one or more training cores, a gradient descent operation on the loss function with respect to the weights of the prediction artificial neural network.

7. The method of claim 1, further comprising:
periodically updating the weights of the target artificial neural network via a copy engine by copying the weights of the prediction artificial neural network into the target artificial neural network memory.

8. The method of claim 1, further comprising:
repeating the applying, selecting, storing, and adjusting steps for each step of an episode of training.

9. The method of claim 8, further comprising:
performing multiple episodes of training to train the prediction artificial neural network.

10. A machine learning device for training a prediction artificial neural network, the machine learning device comprising:
a set of memories including a replay memory, a prediction network weight memory, and a target network weight memory;
one or more inference cores configured to apply state information for time step t to a prediction artificial neural network having weights stored in the prediction network weight memory, to obtain output scores for a set of actions;
an action selection processor, comprising one of the one or more inference cores or a processor other than the one or more inference cores, configured to select an action from the set of actions based on the output scores, for application to an environment, to advance the environment to time step t+1;
a tuple storing processor, comprising one of the one or more inference cores or a processor other than the one or more inference cores, configured to store a tuple for a transition from state sₜ to state sₜ₊₁ into the replay memory, the tuple including the selected action, and a reward provided by the environment; and
one or more training cores configured to adjust weights of the prediction artificial neural network stored in the prediction network weight memory based on application of states sₜ and sₜ₊₁ from the tuple to the prediction artificial neural network and a target artificial neural network having weights stored in the target network weight memory, respectively.

11. The machine learning device of claim 10, wherein adjusting the weights of the prediction artificial neural network includes:
sampling, by one or more training cores, one or more tuples from the replay memory, where each tuple includes a state sⱼ, an action aⱼ, a reward for the action rⱼ, and a subsequent state sⱼ₊₁.

12. The machine learning device of claim 11, wherein adjusting the weights of the prediction artificial neural network further includes:
applying, by the one or more training cores, state sⱼ₊₁ to a target artificial neural network having weights stored in a target network weight memory and obtaining a highest action score output from the target artificial neural network.

13. The machine learning device of claim 12, wherein adjusting the weights of the prediction artificial neural network further includes:
applying, by the one or more training cores, state sⱼ to the prediction artificial neural network to obtain an action score for action aⱼ.

14. The machine learning device of claim 13, wherein adjusting the weights of the prediction artificial neural network further includes:
determining, by the one or more training cores, a loss function based on the highest action score output by the target artificial neural network for state sⱼ₊₁, the action score for action aⱼ output by the prediction artificial neural network, and the reward score rⱼ.

15. The machine learning device of claim 14, wherein adjusting the weights of the prediction artificial neural network further includes:
performing, by the one or more training cores, a gradient descent operation on the loss function with respect to the weights of the prediction artificial neural network.

16. The machine learning device of claim 10, further comprising:
a copy engine configured to periodically update the weights of the target artificial neural network by copying the weights of the prediction artificial neural network into the target artificial neural network memory.

17. The machine learning device of claim 10, wherein the one or more inference cores, the action selection processor, the tuple storing processor, and the one or more training cores are further configured to:
repeat the applying, selecting, storing, and adjusting for each step of an episode of training.

18. The machine learning device of claim 17, wherein the one or more inference cores, the action selection processor, the tuple storing processor, and the one or more training cores are further configured to:
performing multiple episodes of training to train the prediction artificial neural network.

19. A computing device for training a prediction artificial neural network, the computing device comprising:
a central processor configured to interface with an environment by applying actions to the environment and observing states and rewards output by the environment; and
a machine learning device for training the prediction artificial neural network, the machine learning device comprising:
a set of memories including a replay memory, a prediction network weight memory, and a target network weight memory;
one or more inference cores configured to apply state information for time step t to a prediction artificial neural network having weights stored in the prediction network weight memory, to obtain output scores for a set of actions;
an action selection processor, comprising one of the one or more inference cores, configured to select an action from the set of actions based on the output scores, for application to an environment, to advance the environment to time step t+1;
a tuple storing processor, comprising one of the one or more inference cores, configured to store a tuple for a transition from state sₜ to state sₜ₊₁ into the replay memory, the tuple including the selected action, and a reward provided by the environment; and
one or more training cores configured to adjust weights of the prediction artificial neural network stored in the prediction network weight memory based on application of states sₜ and sₜ₊₁ from the tuple to the prediction artificial neural network and a target artificial neural network having weights stored in the target network weight memory, respectively.

20. The computing device of claim 19, wherein adjusting the weights of the prediction artificial neural network includes:
sampling, by one or more training cores, one or more tuples from the replay memory, where each tuple includes a state sⱼ, an action aⱼ, a reward for the action rⱼ and a subsequent state sⱼ₊₁.
